(19) United States
(12) Patent Application Publication
(10) Pub. No.: US 2008/0009238 A1
(43) Pub. Date: Jan. 10, 2008

(54) AVOIDANCE OF MULTIMEDIA SIGNAL DEGRADATION IN A COMMUNICATION DEVICE LOCATED PROXIMATE TO ANOTHER MULTIMEDIA SIGNAL SOURCE

(75) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/428,634

(22) Filed: Jul. 5, 2006

(51) Int. Cl. H04H 1/00

(52) U.S. Cl. 455/3.01

(57) ABSTRACT

A method (300) for selectively conveying multimedia information (110) on a communication device (100). The method may include conveying the multimedia information on the communication device and, responsive to the communication device detecting a second device (120) that is conveying the same multimedia information (110′), automatically changing at least one multimedia conveyance parameter on the communication device.

### BACKGROUND OF THE INVENTION

1. Field of the Invention

The present invention generally relates to mobile communication devices.

2. Background of the Invention

Mobile communication devices typically include a plurality of operational modes. For example, mobile stations are currently available which not only generate a low level audio signal through a transducer that is be held close to the ear like a conventional telephone, but also operate in a hands free speakerphone mode in which they generate a high level audio signal that can be heard from distances of up to two or more meters. Such mobile stations oftentimes also have the capability of presenting multimedia information, for example a television broadcast, to a user.

The use of a mobile station to present multimedia information during hands-free operation is very convenient. For example, if a user desires to monitor a particular sporting event that will begin before the user arrives home from work, the user can listen to the sporting event on his mobile station during his drive home. However, if he leaves his mobile station tuned to the station while he enters a room in which the same sporting event is being broadcasted, the contrast of the signals presented by his home audio/video system and his mobile station can be unpleasant.

### SUMMARY OF THE INVENTION

Embodiments of the present invention relate to a method for selectively conveying multimedia information on a communication device. The method may include conveying the multimedia information on the communication device and, responsive to the communication device detecting a second device that is conveying the same multimedia information, automatically changing at least one multimedia conveyance parameter on the communication device.

Embodiments of the present invention relate to a communication device that includes an output audio transducer that conveys the multimedia information. The communication device further may include a controller that, responsive to the communication device detecting a second device that is conveying the same multimedia information, automatically changes at least one multimedia conveyance parameter on the communication device.

Another embodiment of the present invention may include a machine readable storage being programmed to cause a machine to perform the various steps described herein.

### BRIEF DESCRIPTION OF THE DRAWINGS

Embodiments of the present invention will be described below in more detail, with reference to the accompanying drawings, in which:

FIG. 1 depicts a communication device that conveys multimedia information and a second source of the multimedia information, both of which are useful for understanding embodiments of the present invention;

FIG. 2 depicts a block diagram of a communication device that is useful for understanding embodiments of the present invention;

FIG. 3 is flowchart illustrating a method for selectively conveying multimedia in accordance with an embodiment of the present invention;

FIG. 4 depicts a timeline that is useful for understanding embodiments of the present invention;

FIG. 5 is flowchart illustrating a method for selectively recording multimedia data in accordance with another embodiment of the present invention; and

FIG. 6 is flowchart illustrating a method for selectively marking multimedia data as being conveyed in accordance with another embodiment of the present invention.

### DETAILED DESCRIPTION

While the specification concludes with claims defining features of the invention that are regarded as novel, it is believed that embodiments of the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of embodiments of the invention.

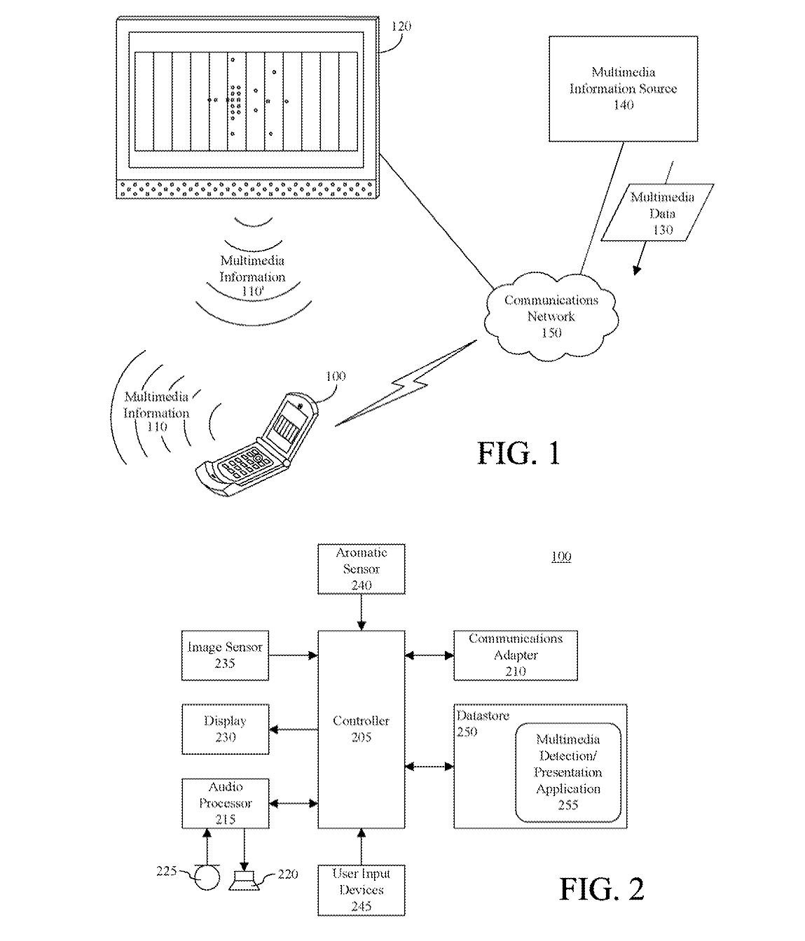

Referring to FIG. 1, certain embodiments of the present invention relate to a method and a system for automatically changing one or more multimedia conveyance parameters on a communication device 100 that conveys multimedia information 110. Specifically, the conveyance parameters can be changed in response to the communication device 100 detecting the same multimedia information 110′ being conveyed by one or more additional devices, such as a second device 120. The conveyance parameters can include, for example, a sound pressure level of an audio signal, an intensity of a video display, a bit rate at which multimedia data 130, from which the multimedia information 110 is reproduced, is delivered to the communication device 100, or any other parameter that may change the manner in which multimedia information 110 is conveyed by the communication device 100.

The conveyance parameters also can include activation and deactivation of conveyance of the multimedia information 110 on the communication device 100. For example, in response to detecting the multimedia information 100′ being conveyed by the second device 120, the first communication device 100 can deactivate its conveyance of the multimedia information 100 and enter standby mode, thereby preserving battery life on the communication device 100. Moreover, the communication device 100 can cease downloading the multimedia data 130 from a multimedia information source 140, thereby reducing use of network bandwidth on the communications network 150 over which the communication device 100 receives the multimedia data 130. Should the communication device 100 lose detection of the second device 120, the communication device 100 can exit standby mode and again convey the multimedia information 110.

In an arrangement in which the second device 120 is a communication device, for instance a telephone, the multimedia data 130 can be generated by the second device 120 (i.e. the second device 120 is the multimedia information source). Further, when a user of the second device 120 (second user) begins speaking, the multimedia information 110′ may be generated by the second user. Thus, in this instance, both the communication device 100 and the second device 120 can simultaneously receive the multimedia information 110′. In response to detecting the multimedia information 100′ being conveyed by the second person, the communication device 100 can deactivate its conveyance of the multimedia information 110, cease download of the multimedia data 130 and/or implement any other suitable processes described herein.

In another aspect of certain embodiments of the invention, the communication device 100 can automatically synchronize its conveyance of the multimedia information 110 with the conveyance of the multimedia information 110′ from the second device 120 or any additional devices. For example, if the communication device receives the multimedia data 130 prior to the multimedia information 110′ being conveyed by the second device 120, the communication device 100 can delay its conveyance of the multimedia information 110 by an amount of time appropriate to achieve temporal synchronization with the multimedia information 110′. Such synchronization will be described herein in greater detail.

In another arrangement, at least a portion of the multimedia data 130 can be recorded by the communication device 100, the second device 120 and/or any additional detected devices. Portions of the multimedia data 130 that are recorded can correspond to portions of the multimedia information 110, 110′ that are conveyed when the communication device 100 and the second device 120 (or other devices) are no longer located proximate to one another. For example, the second device 120 can be configured to begin recording the multimedia data 130 when it loses detection of the communication device 100, and/or the communication device 100 can be configured to begin recording the multimedia data 130 when it loses detection of the second device 120.

In yet another arrangement, if the second device 120 is recording the multimedia data 130 while the communication device 100 is located proximate to the second device 120, the second device can mark at least a portion of the multimedia data 130 as having been conveyed to the user. Such marking can cease when the communication device 100 and the second device 120 are no longer located proximate to one another, for instance when the communication device 100 loses detection of the second device 120 or when the second device 120 loses detection of the communication device 100.

As used herein, the term multimedia information is audio information, video information and/or aromatic information that may be conveyed to a user. To convey such information is to detect, send, receive and/or present the information. The communication device 100 can be, for example, a mobile station, a telephone, a computer, an audio/video system, a telephone answering machine, or any other multimedia conveyance device. Similarly, the second device 120 also can be a mobile station, a telephone, a computer, an audio/video system, a telephone answering machine, or any other multimedia conveyance device.

The multimedia information source 140 can be a multimedia server, another communication device, or any other device which can propagate the multimedia data 130 to the communication device 100 over the communications network 150. Although the second device 120 and the multimedia information source 140 are depicted as separate entities, in one arrangement the second device 120 and the multimedia information source 140 can be a single device. For instance, the second device 120 can be another communication device that is communicating with the communication device 100, for example in a call session. Moreover, the second device 120 can be a telephone (mobile or landline) operating in speakerphone mode.

The communications network 150 can include the Internet, the World Wide Web, a wide area network (WAN), a local area network (LAN), a cellular communications network, a public switched telephone network (PSTN), or any other communications network over which multimedia information can be propagated. In that regard, the communication device 100 and the second device 120 can communicate with the multimedia information source 140 via wired and/or wireless communication links.

FIG. 2 depicts a block diagram of an example of the communication device 100 that is useful for understanding certain embodiments of the invention. The communication device 100 can include a controller 205. The controller 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 100 also can include a communications adapter 210 with which the communication device 100 receives the multimedia data and/or other data, for instance telecommunications data. The communications adapter 210 can be any communications adapter compatible with the communications network to which the communications device 100 is linked. In that regard, the communications adapter 210 can be a wired and/or a wireless communications adapter. For example, the communications adapter 210 can include a receiver or transceiver that receives multimedia data from a television broadcast, IEEE 802 wireless communications, WPA, WPA2, GSM, TDMA, CDMA, WCDMA, Bluetooth, direct wireless communication, TCP/IP, or from any other signal transmitted in accordance with a protocol suitable for communicating multimedia data. Moreover, the communications adapter 210 also can include a network adapter, a serial communications port, a parallel communications port, or any other suitable port through which the device 100 can receive signals communicated over a wired link.

An audio processor 215 can be provided for processing audio signals to be propagated via an output audio transducer 220 (e.g. a loudspeaker) or audio signals received via an input audio transducer 225 (e.g. a microphone). The audio processor 215 can be integrated with the controller 205, or provided as a separate component that is communicatively linked to the controller 205. In one arrangement, the audio processor 215 can be integrated into a separate device, such as a headset, that communicates with the controller 205 via a wired communication link or a wireless communication link, for instance a Bluetooth communication link. The audio processor 215 can comprise a central processing unit (CPU), a digital signal processor (DSP), an application specific integrated circuit (ASIC), a programmable logic device (PLD), a plurality of discrete components that cooperate to process audio data, and/or any other suitable audio processing device.

The input audio transducer 225 can be integrated into the device in which the audio processor 215 is integrated, or otherwise communicatively linked to the audio processor 215. For instance, the input audio transducer 225 can be integrated in a wearable item and communicatively linked to the audio processor 215.

The communication device 100 also can include a display 230 for displaying video information. The display 230 can comprise a liquid crystal display (LCD), a plasma display, a cathode ray tube (CRT), a digital light processing (DLP) display, a liquid crystal on silicon (LCoS) display, or any other display suitable for conveying video information.

An image sensor 235 also can be provided. The image sensor can include a charge-coupled device (CCD), a complementary metal oxide semiconductor (CMOS) image sensor, or any other image sensor suitable for capturing video information conveyed by the second device in a manner suitable for the video information to be processed by, for instance, the controller 205. The image sensor 235 can be integrated with the communication device 100 or operatively coupled to the communication device 100. For example, the image sensor 235 can be provided in a camera that is communicatively linked to the communication device 100 via a wired or wireless communication link. In one arrangement, the camera can be integrated into a wearable article, for instance eyeglasses, a hat, jewelry, an article of clothing, etc.

An aromatic sensor 240 can be integrated with the communication device 100 or otherwise communicatively linked to the communication device 100. The aromatic sensor 240 can include a mass spectrometer, a smell sensor, or any other device suitable for detecting aromatic information. Such detectors are known to the skilled artisan.

The communication device 100 also can include one or more user input devices 245, for example a keypad, touch screen or the like, and a datastore 250. The datastore 250 can include a magnetic storage medium, an electronic storage medium, an optical storage medium, a magneto-optical storage medium, or any other storage medium suitable for storing digital information. In one arrangement, the datastore 250 can be integrated into the controller 205.

A multimedia detection/conveyance application 255 can be contained on the datastore 250. The multimedia detection/conveyance application 255 can be executed by the controller 205 to convey multimedia information on the communication device 100, receive multimedia information from the second device, compare audio and/or video information, and implement other processes described herein.

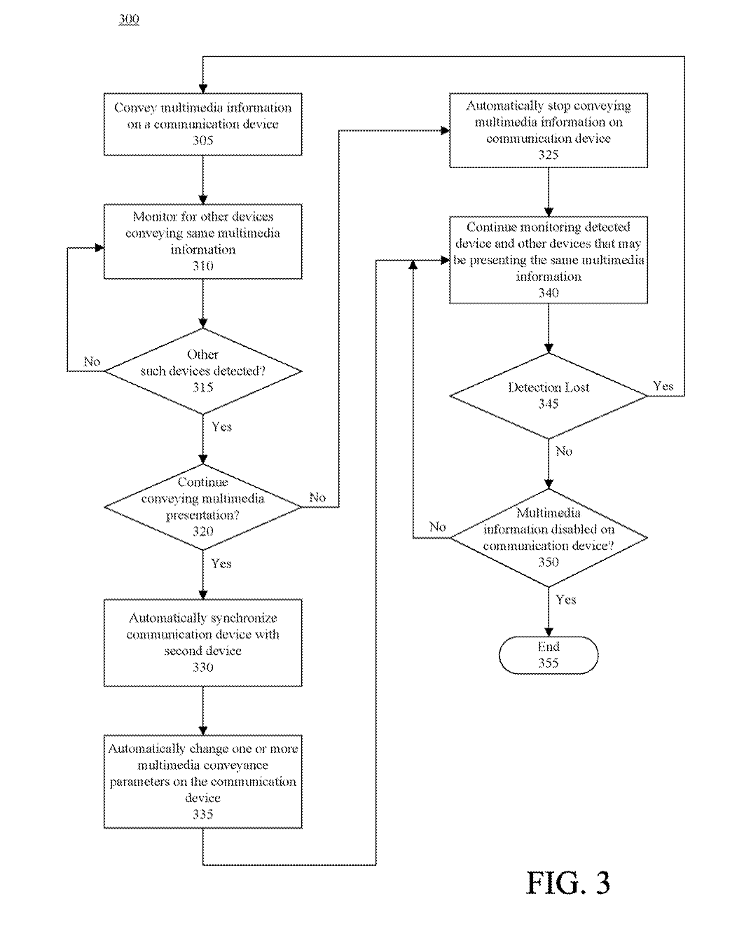

FIG. 3 is flowchart illustrating a method 300 for selectively conveying multimedia in accordance with an embodiment of the present invention. Beginning at step 305, multimedia information can be conveyed on the communication device. As noted, the multimedia information can include audio information, video information and/or aromatic information.

At step 310, the communication device can monitor for other devices that are conveying the same multimedia information. The communication device can monitor for such devices using any of a myriad of suitable detection techniques. For example, in one arrangement other devices can transmit a signal, such as an inaudible acoustic signal (i.e. at a frequency above 20 kHz or below 20 Hz), an infrared signal, or an RF signal that can be detected by the communication device. The signal can communicate identification information that identifies the multimedia information being conveyed by such other devices. Alternatively, the communication device can transmit such a signal, and other communication devices can respond to the signal.

In another arrangement, the communication device can detect multimedia information conveyed by other devices and compare the detected information to multimedia information being conveyed by the communication device. Based on the comparison, the communication device can determine whether the multimedia information conveyed by the other devices matches the multimedia information that it is conveying. The determination of whether the multimedia information conveyed by another device matches the multimedia information conveyed by the communication device can be accomplished in any suitable manner and will be discussed herein in greater detail.

Proceeding to decision box 315, the communication device can continue monitoring for other devices conveying the same multimedia information while such devices remain undetected. Referring to decision box 320, if one or more devices are detected, a decision can be made whether to continue conveying the multimedia information on the communication device. Such decision can be based on device settings or user preferences. If it is decided to stop conveying the multimedia information on the communication device, a multimedia conveyance parameter can be changed to automatically deactivate, or stop, such conveyance, as shown in step 325. Should detection of the second device be lost after deactivating the conveyance, a multimedia conveyance parameter can be changed to re-activate conveyance of the multimedia information on the communication device.

If it is decided to continue with the multimedia conveyance, at step 330 the communication device can automatically temporally synchronize its conveyance of the multimedia information with the conveyance of the other device(s). Synchronization of the communication device with other devices can be accomplished in any suitable manner. In one arrangement, the communication device can communicate with one or more detected devices, for example over a Bluetooth communication link, to select an absolute system time reference to coordinate conveyance of the multimedia information. The system time reference can be, for instance, a global positioning satellite (GPS) time reference or a communications network time reference. After a time reference is selected, the device which is ahead in conveying the multimedia information can halt or slow its conveyance until another device catches up. Alternatively, the device which is behind in conveying the multimedia information can skip a portion of its conveyance or increase conveyance speed until it catches up to the other device(s).

At step 335, one or more conveyance parameters on the communication device can be automatically changed. As noted, the conveyance parameters can include a sound pressure level of an audio signal, an intensity of a video display, a bit rate at which multimedia data is delivered to the communication device, or any other parameter that may change the manner in which multimedia information is conveyed by the communication device. In one aspect of certain embodiments of the invention, sound pressure levels for audio information generated by one or more of the respective devices can be selectively changed so that a combined sound pressure level of the audio signals generated by the respective devices is approximately equal to a desired total sound pressure level. Similarly, the video intensity for video information generated by the respective devices can be selected so that the total video intensity generated by the devices is approximately equal to a desired total video intensity.

At step 340, the communication device 100 can continue monitoring the detected device and for other devices conveying the same multimedia information. Referring to decision box 345, if detection of the second device and/or other devices conveying the same multimedia information is lost, the process can proceed to step 305 and the multimedia information again can be conveyed on the communication device. If at step 320 the communication device had continued conveying the multimedia information, any multimedia conveyance parameters that had changed in step 335 can be set to their original values. Referring to decision box 350, if conveyance of the multimedia information on the communication device is disabled, the process can end at step 355.

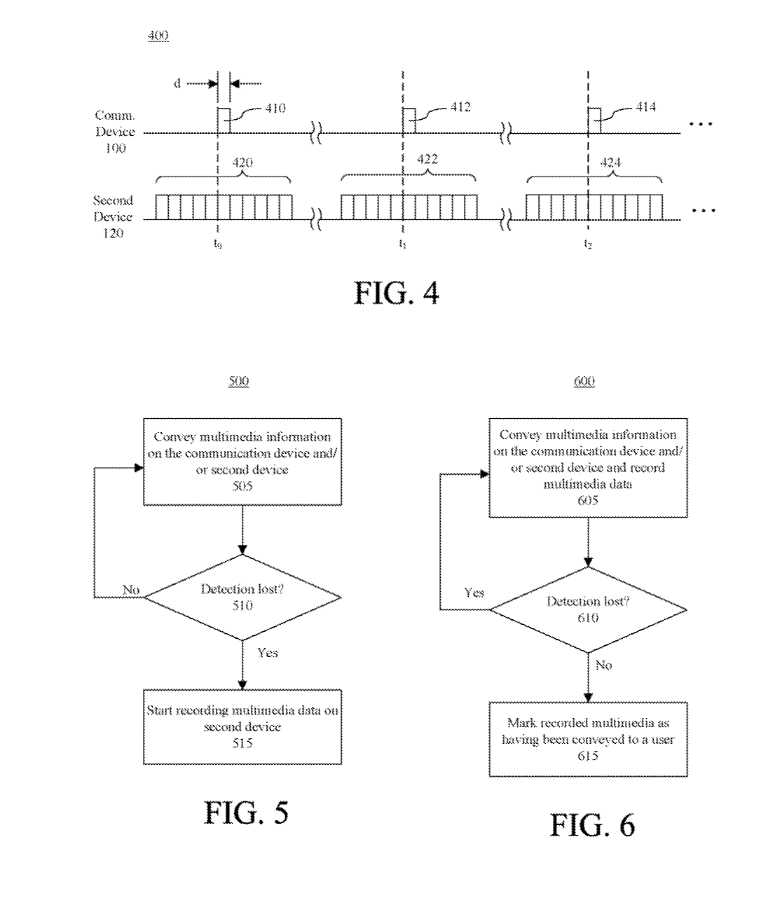

FIG. 4 depicts a timeline 400 that is useful for understanding one technique for determining whether the multimedia information conveyed by the second device 120 matches the multimedia information conveyed by the communication device 100. The timeline 400 represents snippets 410, 412, 414 of multimedia information conveyed on the communication device 100 and snippets 420, 422, 424 of multimedia information conveyed on the second device 120. The snippets 410-424 can include any desired duration (d) of the multimedia information. For example, the snippets 410-424 can include 10 mS, 50 mS or 100 mS of multimedia information.

The snippets 410, 412, 414 can be periodically identified from the multimedia information conveyed on the communication device 100 for comparison purposes. For example, a snippet 410, 412, 414 can be identified every one-half second, every second, ever three seconds, or at any other desired interval. At the same interval in which the snippets 410, 412, 414 are identified, a plurality of snippets 420, 422, 424 can be identified from the multimedia information conveyed on the second device. The snippets 420, 422, 424 can be detected by the input audio transducer, the image sensor and/or the aromatic sensor of the communication device. In that regard, the snippets 410-424 can include audio information, video information, aromatic information, or any combination of such information.

Whereas a single snippet 410 may only be needed for a particular time instance to, detecting a plurality of snippets 420 can help to compensate for any conveyance delay that may be occurring on either the communication device 100 or the second device 120. In particular, a plurality of snippets 420 can be detected prior to the time instance to and a plurality of snippets 420 can be detected after the time instance to. The snippet 410 then can be compared to each of the snippets 420 until a match is found, which signifies the multimedia information conveyed by the second device 120 matches the multimedia information conveyed by the communication device 100. If no match is found, a snippet 412 can be compared to snippets 422. The process can continue until a match is found, the selective conveyance of multimedia function is turned off on the communication device 100, or the communication device is turned off.

Comparison of the snippets 410-414 to the snippets 420-424 can be performed in any suitable manner. For example, if the snippets 410, 420 comprise audio information, the spectral content of the snippet 410 can be compared to the spectral content of the snippet 420. Comparing the spectral content of a first audio signal to the spectral content of a second audio signal is known to the skilled artisan. In addition, noise canceling methods can be implemented reduce the impact of background noise during the comparison.

If the snippets 410, 420 comprise video information, edge and/or object recognition can be used to potentially identify the shape of the second device as a known multimedia device, and image recognition/matching can be applied to match one or more images being conveyed in the snippet 410 with one or more images being conveyed in the snippets 420. Edge/object recognition and image recognition/matching are known the skilled artisan.

If the snippets 410, 420 comprise aromatic information, the aromatic sensor can be used to analyze the aromatic information contained in each snippet 410, 420. The results of the analysis of each snippet 410, 420 then can be compared using known techniques. In some instances aromatic information may linger, especially in an indoor environment. In such circumstances, comparison of a single snippet 420 to the snippet 410 at each time instance t₀, t₁, t₂ may be adequate.

FIG. 5 is flowchart illustrating a method 500 for selectively recording multimedia data in accordance with another embodiment of the present invention. At step 505, multimedia information can be conveyed on the communication device and the second device. Alternatively, the multimedia information can be conveyed exclusively on the communication device or conveyed exclusively on the second device. Referring to decision box 510, the conveyance can continue until detection between the communication device and the second device is lost. Detection being lost can be indicated to the second device in any suitable manner. For instance, while the communication device maintains detection of the second device, the communication device can transmit an inaudible acoustic signal, an infrared signal, or an RF signal. The communication device can stop transmitting the signal when it loses detection of the second device. Proceeding to step 515, the second device then can begin recording multimedia data from which the multimedia information is conveyed. The multimedia data can be recorded to any suitable storage medium.

FIG. 6 is flowchart illustrating a method 600 for selectively marking multimedia data as being conveyed in accordance with another embodiment of the present invention. At step 605 multimedia information can be conveyed on the communication device and the second device. Alternatively, the multimedia information can be conveyed exclusively on the communication device or conveyed exclusively on the second device. Multimedia data from which the multimedia information is generated can be recorded on at least one of the devices. At decision box 610, while detection of the second device by the communication device is maintained, the device(s) recording such multimedia data can mark the recorded multimedia information as having been conveyed to a user. The portion of the multimedia data that is marked can correspond to the multimedia information conveyed by the second device when the second device is detected by the communication device. The multimedia can be marked by setting a flag in a header or footer of a data packet or frame, or marked in any other suitable manner.

Embodiments of the present invention can be realized in hardware, software, or a combination of hardware and software. Embodiments of the present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. Embodiments of the present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A method for selectively conveying multimedia information on a communication device, comprising:
conveying the multimedia information on the communication device; and
responsive to the communication device detecting a second device that is conveying the same multimedia information, automatically changing at least one multimedia conveyance parameter on the communication device.

2. The method of claim 1, wherein changing the multimedia conveyance parameter on the communication device comprises deactivating conveyance of the multimedia information.

3. The method of claim 1, wherein changing the multimedia conveyance parameter comprises changing at least one parameter selected from the group consisting of a sound pressure level of an audio signal and an intensity of a video display.

4. The method of claim 1, wherein changing the multimedia conveyance parameter comprises changing a bit rate at which multimedia data is provided to the communication device.

5. The method of claim 1, wherein changing the multimedia conveyance parameter comprises temporally synchronizing the multimedia information conveyed on the first device with the multimedia information conveyed on the second device.

6. The method of claim 5, wherein changing the multimedia conveyance parameter further comprises changing a sound pressure level of a first audio signal on the communication device such that a combined sound pressure level of the first audio signal and a second audio signal generated by the second device is approximately equal to a desired total sound pressure level.

7. The method of claim 1, further comprising identifying the multimedia information as having been conveyed to a user.

8. The method of claim 1, further comprising selectively recording multimedia data corresponding to at least one portion of the multimedia information.

9. The method of claim 8, wherein selectively recording the multimedia data comprises recording the multimedia data when detection of the second device is lost.

10. The method of claim 8, further comprising marking at least a portion of the multimedia data as being conveyed to a user, the marked portion of the multimedia data corresponding to multimedia information conveyed by the second device when the second device is detected by the communication device.

11. A communication device, comprising:
an output audio transducer that conveys multimedia information; and
a controller that, responsive to the communication device detecting a second device that is conveying the same multimedia information, automatically changes at least one multimedia conveyance parameter on the communication device.

12. The communication device of claim 11, wherein the multimedia conveyance parameter that is changed deactivates conveyance of the multimedia information.

13. The communication device of claim 11, further comprising a video display, wherein the multimedia conveyance parameter comprises at least one parameter selected from the group consisting of a sound pressure level of an audio signal and an intensity of the video display.

14. The communication device of claim 11, wherein the multimedia conveyance parameter comprises a bit rate at which multimedia data is provided to the communication device.

15. The communication device of claim 11, wherein the multimedia conveyance parameter synchronizes the multimedia information conveyed on the first device with the multimedia information conveyed on the second device.

16. A machine readable storage, having stored thereon a computer program having a plurality of code sections comprising:
code for conveying multimedia information on a communication device; and
code for automatically changing at least one multimedia conveyance parameter on the communication device in response to the communication device detecting a second device that is conveying the same multimedia information.

17. The machine readable storage of claim 16, wherein the code for changing the multimedia conveyance parameter on the communication device comprises code for deactivating conveyance of the multimedia information.

18. The machine readable storage of claim 16, wherein the code for changing the multimedia conveyance parameter comprises code for changing at least one parameter selected from the group consisting of a sound pressure level of an audio signal and an intensity of a video display.

19. The machine readable storage of claim 16, wherein the code for changing the multimedia conveyance parameter comprises code for changing a bit rate at which multimedia data is provided to the communication device.

20. The machine readable storage of claim 16, wherein the code for changing the multimedia conveyance parameter comprises code for synchronizing the multimedia information conveyed on the first device with the multimedia information conveyed on the second device.
